(19) United States
(12) Patent Application Publication
(10) Pub. No.: US 2006/0275536 A1
(43) Pub. Date: Dec. 7, 2006

(54) GRAIN PRODUCT WITH INCREASED SOLUBLE FIBER CONTENT AND ASSOCIATED METHODS

(76) Inventors: Joshua Reid, Minnetonka, MN (US); Douglas J. Novak, Big Lake, MN (US); Daniel J. Lewandowski, Bloomington, MN (US)

Correspondence Address: GENERAL MILLS, INC.;NUMBER ONE GENERAL MILLS BLVD, P O BOX 1113, Minneapolis, MN, 55440, US

(21) Appl. No.: 11/421,280

(22) Filed: May 31, 2006

Related U.S. Application Data
(60) Provisional application No. 60/686,674, filed on Jun. 2, 2005.

(51) Int. Cl. A21D 13/00

(52) U.S. Cl. 426/549

(57) ABSTRACT

An improved method for hydrolysis of a grain product results in an increase soluble fiber content without producing undesirable levels of by-products associated protein hydrolysis. The method comprises mixing at high shear a mixture with a grain product having dietary fiber, a base and water at a pH from about 10 to about 13. A homogenous mixture is formed that hydrolyzes following heating with respect to the insoluble fiber. As described herein, a grain product can comprise at least about 30% dietary fiber comprising polysaccharides with arabinoxylan linkages, having at least about 8% soluble fiber, a ratio of soluble fiber to insoluble fiber of at least about 0.1 and no more than about 500 ppm total lysinoalanine. Similarly, some food compositions can comprise at least about 15% soluble fiber with polysaccharides having arabinoxylan linkages, from about 35% to about 65% water, a pH from about 10 to about 13.

### CROSS-REFERENCE TO RELATED APPLICATIONS

This application claims the benefit of priority under 35 U.S.C. 11 g(e)(1) of a provisional patent application Ser. No. 60/686,674, filed Jun. 2, 2005, which is incorporated herein by reference in its entity.

### FIELD OF THE INVENTION

The invention relates to food products especially grain brans with increased amounts of soluble fiber relative to the native product. In particular, the grain product has reduced amounts of undesirable protein hydrolysis by-products while achieving desired increases in soluble fiber. The invention also relates to an alkaline hydrolysis method for increasing the soluble fiber content of a high fiber product while reducing or eliminating such protein hydrolysis by-products.

### BACKGROUND OF THE INVENTION

There is a large amount of information in circulation today concerning elevated cholesterol levels and the health consequences believed due to that condition. In an effort to combat elevated cholesterol levels, a number of pharmaceutical applications, dietary supplements and other solutions relating to the treatment of high cholesterol levels have been previously introduced. However, in particular some dietary products have unpleasant attributes, such as mouth feel, i.e., they can feel slimy or sticky or have a displeasing taste, or undesirable side effects, which diminishes their overall value to the intended end user.

In addition, there also appears to be a growing undesirability against ingesting a dietary supplement, a pharmaceutical treatment or other supplement-type product to attain some perceived beneficial effect from such products. This may be due to a growing reliance on pills or tablets to sustain or maintain our health. Some have concerns regarding the popular statins based on pharmaceutical drugs. Moreover, certain supplements may actually remove valuable macronutrients and micronutrients from the system. Individuals may also be concerned with potential risks and side effects associated with certain medications, treatments or supplements. In fact, dietary restrictions and other health concerns may preclude certain portions of the population from even consuming such products.

Cholesterol in humans is known to come from primarily two sources, the body's own production of cholesterol (endogenous) and dietary cholesterol (exogenous). Lipoproteins contain specific proteins and varying amounts of cholesterol, triglycerides and phospholipids. There are three major classes of lipoproteins, very low-density lipoproteins (“VLDL”), low-density lipoproteins (“LDL”) and high density lipoproteins (“HDL”). The LDLs are believed to carry about 60-70% of the serum cholesterol present in an average adult. The HDLs carry around 20-30% of serum cholesterol with the VLDL having around 1-10% of the cholesterol in the serum. To calculate the level of non-HDL cholesterol present for the determination of the combined level of LDL and VLDL, which correlates with health risk, the HDL is subtracted from the total cholesterol value.

Typically, the average person consumes between 350-400 milligrams of cholesterol daily, while the recommended intake is around 300 milligrams. Increased dietary cholesterol consumption, especially in conjunction with a diet high in saturated fat intake, can result in elevated serum cholesterol. Having an elevated serum cholesterol level is a well-established risk factor for heart disease, and therefore there is a desire to mitigate the undesired effects of cholesterol accumulation. High cholesterol levels are generally considered to be those total cholesterol levels at 200 milligrams and above or LDL cholesterol levels at 130 milligrams and above. By lowering the total system LDL cholesterol level, it is believed that certain health risks, such as coronary disease and possibly some cancers, that are typically associated with high cholesterol levels, can be reduced by not an insignificant amount.

Bile acids are synthesized from cholesterol in the liver and then secreted into the intestines. Reducing the level of bile acid reabsorption facilitates the maintenance of a healthy cholesterol level. One method for reducing bile acid reabsorption is achieved by increasing the viscosity of flow through the intestines. Alternatively, a non-digestible dietary component which binds bile acids secreted in the proximal jejunum can reduce bile acid reabsorption in the lower intestines (distal ileum).

Numerous studies relating to modifying the intestinal metabolism of lipids have been done to illustrate that such effects can reduce a high cholesterol level. Hampering the absorption of triglycerides, cholesterol or bile acids or a combination of these items results in a lowering of cholesterol levels in the serum.

Soluble fiber typically remains undigested, except by colonic microflora present in the lower intestines. Soluble dietary fiber is believed to have a beneficial effect in the reduction of high serum cholesterol levels and reducing the risk associated with such elevated levels. In addition, soluble dietary fiber can have the additional beneficial effect of reduced constipation and improved regularity. However, too much fiber in the diet can create undesirable gastrointestinal side effects such as flatulence, diarrhea, and abdominal cramps, etc. leading consumers to stay away from food products that contain too much dietary fiber, regardless of any associated health benefits. While some consumers may not completely avoid such products, they also do not typically regularly use such products due to the problems enumerated above or alternatively, or in combination due to the unpleasant taste of such products.

### SUMMARY OF THE INVENTION

In a first aspect, the invention pertains to methods for treating a grain product to increase its soluble fiber content. The method comprises mixing a grain product having a native dietary fiber content including a native soluble fiber concentration with an alkaline base and water with a high shear to form an homogeneous wet alkaline mixture having a pH from about 10 to about 13. The homogenous wet mixture can then be heated to hydrolyze at least a portion of the dietary fiber contents for times and temperatures sufficient to increase the soluble fiber content to at least 1.75× its native soluble fiber concentration. The method includes adding sufficient edible acid to reduce the pH to about 6.5 to 7.5 to form a neutralized grain product with a raised soluble fiber content.

In a further aspect, the invention pertains to a grain product comprising at least about 20% dietary fiber comprising polysaccharides with arabanoxylan linkages, having at least about 8% soluble fiber, a ratio of soluble fiber to insoluble fiber of at least about 1:10 and no more than about 500 ppm total lysinoalanine.

In another aspect, the invention pertains to a food composition comprising at least about 15% soluble fiber with polysaccharides having arabanoxylan linkages, from about 35% to about 65% water, a pH from about 10 to about 13.

### BRIEF DESCRIPTION OF THE DRAWINGS

FIG. 1 is a schematic view of an extrusion based apparatus for the hydrolysis and cooking of a grain product to hydrolyze dietary fiber within the composition.

FIG. 2 is a plot of total lysinoalanine and free lysinoalanine for fifteen batch runs performed according to Example 1.

FIG. 3 is a plot of total lysinoalanine and free lysinoalanine for batch runs with different amounts of L-cysteine added to the hydrolysis mixture.

### DETAILED DESCRIPTION OF THE INVENTION

Grain products with high fiber contents are described that have increased soluble fiber contents through the hydrolysis of initial insoluble fiber in the product while reducing by-products indicative of protein hydrolysis. The high fiber grain products generally comprise a significant portion of grain bran. The present hydrolyzed bran products have little if any free lysinoalanine. An improved method for the formation of a high fiber product with increased soluble fiber content involves the application of high shear to a hydrolysis mixture such that a uniform mixture is heated to hydrolyze the fiber compositions within the grain product. High shear can be conveniently practiced as a continuous method with an extruder or the like, although a high shear batch method variation can also be used. In some embodiments, L-cysteine is added to reduce undesired protein hydrolysis. The improved products are considered safe for human consumption and can be incorporated into one or more of a range of consumable products. The high soluble fiber compositions can be consumed to reduce human serum cholesterol levels.

Throughout the specification and claims, percentages are by weight and temperature in degrees Centigrade unless otherwise indicated. Each of the referenced patents and patent applications are incorporated herein by reference.

Grain seeds have three principle components, the pericarp or bran, the endosperm and the germ. The germ contains the plant embryo and generally has the oil rich portion of the seed. The endosperm is primarily starch and protein to supply the growing embryo with these nutrients. The bran is a fibrous outer portion of the seed that provides protection for the seed. In wheat products, the germ and bran can be removed to make white flours. The bran, however, can be desired for its fiber components.

The bran generally comprises both soluble and insoluble fibers. The total fiber content, i.e., the total of the soluble fiber and insoluble fiber, is referred to as the dietary fiber content. As described above, soluble fiber in particular has been associated with particular health improvements. Therefore, for individuals that want to limit their total dietary fiber intake, it is desirable to increase the ratio of soluble fiber to insoluble fiber. The soluble fiber content of regular wheat bran is approximately 2.2% on a dry weight basis. Wheat shorts, oat hulls, corn cobs and other sources having high levels of insoluble fiber material can also be used instead of wheat bran as a high fiber source material for the process to increase the soluble fiber content. To achieve desired product compositions, the grain composition as a starting material for the hydrolysis method generally has a high dietary fiber content, as described further below.

It has been found that through the treatment of wheat bran with enzymes (cellulases and xylanases) the soluble fiber content can be increased to twice (“2×”) its native level to approximately 4.4% on a dry weight basis. However, more significant improvement in increasing the soluble fiber content can be obtained by treatment of a high fiber starting material with water and alkali, i.e., base to form a wet alkaline material, and then heating the wet alkaline material to hydrolyze at least a portion of the insoluble fiber content to form a treated material having a higher soluble fiber content. The treated material can be acidified to a neutral pH and dried to form a loose particulate finished product. The finished product can be ground or milled into a very fine powder, if desired. In improved embodiments, the composition is subjected to high shear during or before the heating method to obtain improved product properties, especially reduced amounts of undesirable protein hydrolysis products. The soluble fiber content of the material can be increased to levels of at least double from the initial soluble fiber content.

A method involving an alkaline cooking method for hydrolyzing insoluble fiber to increase the soluble fiber content of a bran method is described in co-pending U.S. patent application Ser. No. 10/207,601 filed on Jul. 29, 2002 to Dreese et al., entitled “Method And Ingredient For Increasing Soluble Fiber Content To Enhance Bile Acid Binding, Increase Viscosity, And Increase Hypocholesterolemic Properties.” However, using the method as described in this published application, an undesirable amount of protein hydrolysis products can be formed. In the improved method described herein, the protein hydrolysis products can be reduced to more desirable levels.

The improved methods for increasing soluble fiber content comprise the heating of a mixture of the grain product, a base/alkali and water under pressure to effectuate the fiber hydrolysis. The pressure, temperature and heating time can be adjusted to yield the desired degree of hydrolysis. In general, the method is conducted at a temperature above 100° C. for a time of at least about 10 minutes. In embodiments of particular interest, the mixture of grain product, base and water is mixed at high shear to form a highly uniform mixture. Additional details of an appropriate method are described below. In one approach to apply high shear, the mixture passes through an extruder in a continuous process. The use of an extruder provides advantages with respect to the efficiencies associated with a continuous process. The amount of water and base can be appropriately controlled to produce a hydrolysis product with desired properties.

In some embodiments, the hydrolysis product with increased soluble fiber content has levels of protein hydrolysis products below selected thresholds. In particular, lysinoalanine (LAL) moieties are desired to be below particular levels since high levels have been associated with health concerns. Protein hydrolysis under some conditions has been observed to yield increases in both free lysinoalanine, i.e., the dipeptide, as well as total lysinoalanine, which includes lysinoalanine dipeptides within protein structures. The use of high shear in the hydrolysis method has been discovered to reduce LAL levels in the resulting high soluble fiber product. While not wanting to be limited by theory, this improved result may result from reduction or elimination of regions with high base concentrations, i.e., particularly high pH, prone to undesirable protein hydrolysis, as a result of the more uniform mixture of the base under high shear within the hydrolysis mixture. If desired, it has been found that addition of L-cysteine amino acids can reduce total LAL levels at the expense of increased free LAL levels.

Following completion of the hydrolysis method, the mixture can be neutralized with an appropriate amount of edible acid. Then, the high soluble fiber product can be dried for later use or directly incorporated into a food product. While the high soluble fiber food product can be directly eaten by a consumer, in many cases, the product is combined with other edible components to form a commercial food product. Suitable commercial food products include, for example, any high fiber product, such as breakfast cereals, baked products, e.g., breads and muffins, breakfast bars and the like.

While improved health effects from an increase in soluble fiber consumption may be hoped, direct evidence has been obtained that establishes that serum cholesterol levels are actually reduced from the consumption of the hydrolyzed fiber products described herein that have proportionally greater amounts of soluble fiber relative to insoluble fiber. These health benefits are described further in co-pending U.S. patent application Ser. No. 10/207,601 filed on Jul. 29, 2002 to Dreese et al., entitled “Method And Ingredient For Increasing Soluble Fiber Content To Enhance Bile Acid Binding, Increase Viscosity, And Increase Hypocholesterolemic Properties.” This co-pending application describes a related hydrolysis method that is improved upon herein. The health benefits are further described in co-pending provisional patent application Ser. No. 60/660,016 filed on Mar. 9, 2005 to Reid et al., entitled “High Soluble Fiber Compositions For Cholesterol Reduction.”

Grain Composition Starting Materials

The dietary fiber component of the starting materials described herein can be provided from a wide variety of grains, cereals or components thereof and are composed of polysaccharides having a variety of structures. Dietary fiber, which comprises complex polysaccharides, refers to both soluble and insoluble fiber. Fiber that is particularly amenable to hydrolysis under the conditions described herein without undesirably hydrolyzing protein beyond acceptable levels has an arabinoxylan polysaccharide backbone. Examples of suitable grains or cereals amenable to processing using the approaches described herein include the major cereal grains, for example, wheat, rice, corn, oats, barley, rye and the like. Less preferred, due to their cost and availability, are the other cereal grains, which can be supplied by such minor grains as triticale or by “heritage” grains such as spelt, kamut, quinoa and mixtures thereof. While not produced in large quantities, such heritage grains are especially popular among those interested in organic foods.

As indicated above, dietary fiber is generally resistant to human digestive enzymes, except for colonic microflora present in the lower intestines, and soluble fiber is known for its water and ion-binding capacity. Obtaining an enhanced level of soluble fiber is achieved through the hydrolysis of insoluble fiber in the method described below.

The starting material of the hydrolysis method is generally selected from the group of milling by-products or other grains or components thereof which do not create an economic burden or disincentive to their inclusion into the food intermediate or food product being produced in accordance with the hydrolysis method. In one embodiment, wheat bran is selected for illustration in the following example. It should however be understood that, for example, oat bran, barley bran, rice bran and corn bran may be used in connection with the hydrolysis method. In addition, the starting material can also comprise a mixture of two or more of wheat bran, oat bran, corn bran, rice bran or the like as well as mixtures with other grain components. Bran ingredients are preferred for use herein as starting materials due to their low cost.

Oat flour is essentially heat-treated oat groats (hulled, crushed oats) or rolled oats that are ground on a hammer mill or other machine. There is no separation of the components during the processing of the flour. Oat bran is produced by grinding clean oat groats or rolled oats and separating the resulting flour by suitable means, such as sieving, into fractions such that the oat bran fraction is not more then 50% of the original starting material.

Barley is processed through cleaning, hulling, sieving and then grinding. Waxy hulless barley has a higher dietary fiber content than most other sources of fiber and can range from 14 to 20% of the dry weight.

The principle species of wheat are Triticum aestivum or bread wheat, T durum, which has extra hard kernels used primarily for macaroni and related pasta products, and T. compactum or club wheat, which has very soft kernels. Numerous varieties and cultivars within each species are known.

In the United States, wheat is classified according to whether it is hard or soft, white or red, and winter or spring. As a result there are eight possible designations including, hard white spring, soft white winter, and soft red winter. The white or red designation refers to the color of the wheat kernel. The hard or soft designation refers to protein strength and content of the wheat kernel. Tannin content is also known to be lower in soft wheat than in hard wheat. The winter or spring designation refers to the growth habit of the wheat. Winter wheat is planted in the fall and harvested in the spring, whereas spring wheat is planted in the spring and harvested later that same crop year.

Wheat and generally other whole grains comprise a major starchy endosperm, a smaller germ or sprouting section of the seed and a surrounding bran or husk layer. For wheat, the “endospenn” is the portion typically referred to, upon milling, as “flour” and generally makes up about 81% to about 85% of the wheat kernel. Wheat bran makes up about 11% to about 15% of the kernel with about 1% to about 3.5% being the germ portion. Bran with or without the germ is sometimes referred to as “mill feed.” Mill feed is a low value commodity typically used for animal feed.

Wheat bran is produced by grinding or milling clean wheat and then separating the resulting flour by suitable means, such as sieving, into fractions. Regular wheat bran has only about 2.5% soluble fibers. Wheat bran is relatively inexpensive, although the value of wheat bran can be increased through increasing its soluble fiber content due to its increased health benefits.

Wheat shorts, as used herein, refers to a product or grain that cannot be cleanly separated into bran, germ or endosperm. Wheat shorts are made up of a substantial portion of wheat bran and contain about 40% fiber of which more than half is arabinoxylan. Wheat shorts are available in large quantities. Wheat shorts as used herein are available, for example, from General Mills, Inc. Minneapolis, Minn. Wheat shorts are often by-products of the milling industry.

Application of the improved method described herein are not limited to wheat bran or wheat shorts in achieving higher soluble fiber levels. Instead, the method described herein is suitable for use with any similar carbohydrate/fiber backbone such as those in corn, wheat, barley, oats, rice and portions thereof. For example, where oat hulls are used as the starting material and subjected to the same method the amount of soluble fiber contained in the extract on a dry weight basis can be, for example, 16%, which represents a significant improvement over the soluble fiber content of oat hulls, which normally is in the low single digits on a dry weight basis. Corn bran, oat bran and rice bran are also suitable starting materials.

In another embodiment, mixtures of two or more materials selected from the group of wheat bran, rice bran, oat bran and corn bran may be used.

In summary, the high fiber composition that is used in the method to increase the soluble fiber portion generally has bran components from one or more grains, with wheat bran being of particular interest. To achieve desired levels of soluble fiber content in the product compositions, the initial material should have correspondingly appropriate dietary fiber contents. In some embodiments of interest, the food composition has at least about 30% dietary fiber, in further embodiments at least about 35%, and in additional embodiments from about 38 to about 90% dietary fiber. With respect to soluble fiber, the initial food composition can have low soluble fiber contents, although compositions with moderate or relatively high soluble fiber levels are also suitable if desired. For example, wheat bran generally has only about 2.5% soluble fiber. While an increase in the soluble fiber component of the food composition can be advantageous for any food product, in some embodiments, the initial food product has no more than about 15% soluble fiber, in further embodiments less than about 10% soluble fiber, in other embodiments less than about 5% soluble fiber and in other embodiments only trace amounts of soluble fiber, for example if the grain product had been washed removing much of the soluble fiber. A person of ordinary skill in the art will recognize that additional ranges of fiber content within the explicit ranges above are contemplated and are within the present disclosure.

With respect to distinguishing soluble fiber and insoluble fiber, accepted definitions have been established to distinguish these compositions, as discussed further below. Dietary fibers comprise polysaccharides, such as cellulose and hemicellulose. However, dietary fibers can comprise a range of other polysaccharides with sugar moieties, and the polysaccharides can be polymers or heteropolymers. Dietary fibers also are associated with compounds, such as lignin, an aromatic polymer, as well as waxes, cutin and suberin, which are indigestable fatty acid derivatives intricately tied to polysaccharides in dietary fiber. The associated compositions can serve as chemical crosslinks between the various components and can increase resistance to digestion.

The accepted definition of dietary fiber is essentially unchanged since at least the 1970's. The accepted scientific definition includes, cellulose, hemicellulose, lignin, gums, modified celluloses, mucilages, oligosaccharides, pectins, and associated minor substances, such as waxes, cutin and suberin. The official methodologies for evaluation of these compositions is monitored by the American Association of Cereal Chemists (AACC). An AACC report on a recent committee evaluation is found in an article entitled “The Definition of Dietary Fiber,” Cereal Food World, Vol. 46, No. 3, pp 112-126 (March 2001), incorporated herein by reference.

In addition to tracking accepted definitions of dietary fiber, the AACC also provides official and approved protocols for the evaluation of the dietary fiber content of food products. Corresponding to the AACC methods, there are international official methods sanctioned by AOAC International. As used herein, fiber levels were evaluated using AOAC 991.43 Total, Soluble, and Insoluble Dietary Fiber in Foods—Enzymatic-Gravimetric Method, MES-Tris Buffer. The equivalent AACC method is AACC 32-07. A general principle behind the methods is the determination of the edible parts that are not subject to degradation. As such, the samples are defatted and heated to gelatinize the starch. Then, samples are subjected to protease, amylase and amyloglucosidase (glucoamylase) to break down the digestible components of the food. The residues after the removal of the digestable components are quantified and adjusted for protein and ash to adjust for any contributions from the enzymes themselves. As a control, the enzymes are checked for purity through an examination that they do not digest dietary fiber.

Applicants incorporate herein by reference the full disclosure in AOAC 991.43, including but not limited to the complete procedure for fiber quantification. In this method, MES-Tris buffer replaces a phosphate buffer in older methods. Duplicate 1-gram dried food samples are subjected to sequential enzymatic digestions with heat-stable alpha-amylase followed by protease and then amyloglucosidase. Insoluble dietary fiber is filtered, and the residue is washed with warm distilled water. A solution with the filtrate and water washings is precipitated with 95% ethanol to determine the soluble fiber content. The precipitate is then filtered and dried for the determination of the insoluble fiber content. The insoluble fiber and soluble fiber values are corrected to protein and ash to obtain final values. The methodology is described further also in the book Dietary Fiber Analysis and Applications, by Cho et al., (AOAC International, 1997), incorporated herein by reference.

Hydrolysis Method for Soluble Fiber Increase

In general, a hydrolysis mixture is formed comprising a fiber-based food product, such as wheat bran, water and base/alkali. Suitable fiber-based food products for processing using the methods described herein were described in detail in the previous section. The hydrolysis mixture is heated to modify the hydrolysis mixture, in particular to hydrolyze some of the insoluble fiber to form an increased amount of soluble fiber. The amount of water suitable for use in the present invention ranges from about 20% to in excess of about 2500% as a percent of the weight of the fiber-based solids. Generally, however, it is desirable to use an amount of water that is equal to or less than the dry weight of the fiber-based solids, or in some embodiment from about 20% to about 100% of the dry weight of the fiber-based solids, in other embodiments from about 25% to about 80%, in additional embodiments from about 30% to about 60% and in further embodiments from about 30% to about 50% of the dry weight of the fiber-based solids. A person of ordinary skill in the art will recognize that additional ranges within the explicit ranges above of water content are contemplated and are within the present disclosure.

Handling of viscous soluble fibers can be difficult due to the fact that the fiber has high viscosity. With respect to wheat bran products in particular, it has been discovered that by perfonming the modification as described herein where the solids content of the bran ranges from between about 20% to about 60% and in further embodiments between about 25% to about 50% and for best results ranging from about 20% to 30% relative to the dry weight of the fiber-based solids, e.g., wheat bran solids, significant improvement in the conversion to soluble fiber can be obtained over alternative solutions. A person of ordinary skill in the art will recognize that additional ranges of solid content within these explicit ranges are contemplated and are within the present disclosure. If the moisture content falls outside of this window, it is observed that the material can be either too sticky or slimy due to high water content or in the alternative there is not sufficient moisture in the product, which creates other handling difficulties. More importantly, controlling the moisture content to within the ranges herein is important to obtaining the benefit of increasing the soluble fiber while reducing or eliminating the levels of free LAL. However, other commercial factors can take precedence over the handling issue such that the other amounts of water may be desired in some embodiments.

Calcium hydroxide (Ca(OH)₂), due to its additional nutritional value (increasing calcium level) and cost, is a desirable alkali, i.e. base, however other hydroxides, calcium oxide (CaO), other food-grade base or combinations thereof are also suitable for use in forming an hydrolysis mixture, including but not limited to sodium hydroxide (NaOH) and potassium hydroxide (KOH). In practicing the present invention the amount of calcium hydroxide ranges from about 1% to about 10%, in alternative embodiments from about 3% to about 8% and in additional embodiment from about 4% to about 8% per dry weight of the fiber-based component. For other bases, the weights can be scaled based on the molecular weights to add an equivalent amount of hydroxide ions. The pH of the resulting hydrolysis mixture generally is from about 10 to about 13 and in further embodiments from about 10 to about 12. A person of ordinary skill in the art will recognize that additional ranges of base amounts and pH values within the explicit ranges above are contemplated and are within the present disclosure.

After the addition of the base, additional water can be added to maintain the selected moisture level. For embodiments in which steam is used to supply all or a portion of the heat for cooking/hydrolysis, additional water can enter the mixture by way of condensation of steam that is injected into the cooking apparatus for heat.

In addition to other steps directly relating to the hydrolysis and post-cooking processing of the composition, fine grinding of wheat shorts or wheat bran may also be done (e.g. using a Nisshin Engineering Blade Mill or DPM mill) prior to the cooking. For example, the wheat bran or other fiber-based composition can be ground to an average particle size of no more than 25 microns, in further embodiments no more than about 20 microns and in further embodiments no more than about 16 microns. A person of ordinary skill in the art will recognize that additional ranges of average particle sizes within the explicit ranges above are contemplated and are within the present disclosure. The grinding may or may not be performed prior to the hydrating the material.

In one embodiment, the ingredients of the hydrolysis mixture are mixed together and added into a batch cooker. The hydrolysis mixture is then cooked at atmospheric pressure or alternatively cooked in a pressurized vessel. Heat can be added with steam or through another suitable approach, such as a heating mantle of a heated jacket within the batch cooker. The heating can be done for a total time in the range of about 10 minutes to about 120 minutes, and in further embodiments from about 40 minutes to about 60 minutes. During the heating, the pressure in the vessel can be maintained at about 275-350 kilopascal (≈25 psig to about 36 psig). The cooking temperature can range from about 100° C. to about 140° C. and in further embodiments from about 130° C. to about 138° C. A person of ordinary skill in the art will recognize that additional ranges of heating time, pressures and temperatures within the explicit ranges are contemplated and are within the present disclosure. The heating can be performed in a batch cooker designed and used in the production of ready-to-eat cereals. After the cooking is complete, the contents of the batch cooker can be discharged from the cooker. The contents of the cooker can be cooled prior to opening the cooker, for example, by drawing a vacuum and/or by spraying the composition with cold water.

In improved embodiments, high shear is added to the hydration mixture prior to and/or during cooking. If high shear is added during cooking, the high shear can be applied for all or a selected portion of the cooking time. High shear can be applied with a high shear mixer and/or with an extruder. Surprisingly and significantly improved results are observed when the hydrolysis mixtures are subjected to high shear. Specifically, the results of the method are more uniform and reproducible. In addition, the production of undesirable protein hydrolysis by-products, in particular lysinoalanine levels, is very significantly reduced or eliminated through the application of shear in combination with control of the moisture content to between 20% and 60%, as discussed further below. While not wanted to be limited by theory, a possible explanation for the dramatically improved results is that the base is more evenly distributed through the material such that the hydrolysis reaction takes place at a correspondingly more uniform pH such that extremely high pH, i.e., strongly basic, regions within the mixture are reduced or eliminated that have the capability of hydrolyzing the protein.

The amount of shear is generally correlated with the operating conditions of the apparatus used to apply the shear. Specifically, in a high shear mixer, the mixer can be operated with at least about 50 revolutions per minute (rpm) or the equivalent, in further embodiments from about 100 rpm to about 10,000 rpm and in additional embodiments from about 200 rpm to about 5,000 rpm. Suitable high shear mixers for food products are commercially available. For example, high shear mixers include, for example, IKA Ultra Turrax T50 high shear mixer (IKA Works, Inc., Wilmington, N.C.) and Silverson High Shear Food Mixers (Silverson Machines Ltd., U.K.). The ranges of specific mechanical energy provided below in the context of extrusion can also provide guidance with respect to the high shear mixing since delivery of similar amounts of mechanical energy with a mixer should provide similar results as with delivery with an extruder. In general, the high shear mixing is performed for at least about 1 minute, in further embodiments for at least about 2 minutes, in other embodiments from about 3 minutes to about 30 minutes. A person or ordinary skill in the art will recognize that additional ranges of rpm and mixing times within the explicit ranges above are contemplated and are within the present disclosure.

While an extruder can be used to transport and mix the hydrolysis composition, for convenience and efficiency, the hydrolysis mixture is also cooked within the extruder. Suitable extruders include, single screw extruders and multiple screw extruders, such as twin screw extruders. Multiple screw extruders are particularly desirable since they are particularly suitable for the application of shear. Suitable cooking extruders are available for food products, such as Buhler extruders from the Buhler Group, Switzerland and extruders from Werner & Pfleider Inc. When extrusion cooking is used, the optimal moisture content is around 20-35% or in further embodiments about 23-28% as opposed to roughly the 45-55% range, which may be suitable in the batch cooker.

To apply high shear, a twin-screw extruder can be operated at least at 100 rpm, in further embodiments from 125 rpm to 10,000 rpm and in additional embodiments from about 150 rpm to about 5,000. As is well known in the food processing art, with either a mixer or an extruder, the amount or degree of shear can be characterized or described in terms of the Specific Mechanical Energy. The Specific Mechanical energy is a measure of the mechanical energy or work that the extruder imparts to the material on a unit weight basis. Generally, the high shear method herein involves the application of from about 50 to about 500 W-hr/kg, in further embodiments from about 60 to about 400 W-hr/kg and in additional embodiments from about 75 to about 350 W-hr/kg material.

With respect to a twin-screw extruder, the energy imparted to the material in the extruder is referred to as specific mechanical energy expressed in units of energy/weight (“W-hr./kg”), which drives the cooking method within the extruder. The specific mechanical energy is the delivered mechanical shaft power divided by the total feed rate, i.e.
SME=(delivered mechanical or shaft power)/total feed rate (1)
the total feed rate is the total weight per unit time of all solid and liquid feeds, which can be expressed as kilograms per hour. The delivered power is the difference between the power delivered with the load minus the power delivered with no load. For an extruder powered with an ac motor, the power generally can be read directly from the motor drive in Watts. For an extruder powered with a DC motor, the delivered mechanical shaft power can be evaluated using the following equation:
delivered mechanical power=[(volts)(amps)]_{load}−[(volts)(amps)]_{no load} (2)
To evaluate the no load power, the screws and shafts of the extruder can be removed, and a curve generated of the [(volts)(amps)]_{no load} versus rotational speed. The value of [(volts)(amps)]_{no load} at the actual screw speed can be used for the calculation. The armature voltage and current can be obtained from the DC motor drive. These calculations can be similarly adapted for other high shear apparatuses, such as a single-screw extruder, a three-screw extruder, a high shear mixer and the like.

The use of an extruder has the advantage of being a continuous process. The use of a continuous process can have advantages with respect to processing of large volumes as well as lowering costs for larger volume production. Also, it has been found that a continuous process may improve the color of the resulting product. Extrusion cooking may also further increase the soluble fiber content of the resulting product.

In other embodiments L-cysteine is added to the hydrolysis mixture. In these embodiments, the total LAL levels were found to be reduced, but free LAL levels increased. Generally, from about 0.0005% to about 0.02% of L-cysteine (5-200 ppm) is added to the hydration mixture. A person of ordinary skill in the art will recognize that additional ranges of L-cysteine amounts within this explicit range are contemplated and are within the present disclosure. The desired amount of L-cysteine can be selected to yield the desired balance between total LAL and free LAL. These embodiments can be performed with or without high shear.

After the cooking step is complete, the intermediate product can be mixed with a edible acid to neutralize the mixture. Preferably, an edible organic acid such as citric acid can be used to neutralize the mixture, although edible mineral acids such as hydrochloric acid or other suitable edible acids or mixtures of acids can be used. Food grade citric acid and other edible organic acids are readily available commercially. For citric acid, about 0.82 grams of citric acid can be added for each gram of calcium hydroxide that was initially added to the mixture. In general, the amount of acid can be added to obtain a pH from about 6.5 to about 7.5. A person of ordinary skill in the art can evaluate the appropriate amount of acid to obtain an appropriate final pH.

The neutralized composition can be combined immediately into a food product or dried for later incorporation into a food product. To dry the hydrolyzed mixture, the composition can be heated at a temperature, for example, from about 71° C. (160° F.) to about 100° C. (212° F.) and in other embodiments from about 82° C. to 100° C. (180° F. to about 212° F.), for a suitable period of time to decrease the moisture content to no more than about 20% and in further embodiments no more than about 12%. A person of ordinary skill in the art will recognize that additional ranges of drying temperatures and final moisture levels within the explicit ranges are contemplated and are within the present disclosure. The dried product can be further ground into a powder with a mill.

In addition to the foregoing processes, in order to control or reduce bitter flavors produced by the process, oxidation may be reduced (e.g., through the addition of ozone), the bran may be sheared during cooking or the concentration of the alkali may be changed. If the bran subsequent to treatment is too dark then the color of the bran may be bleached through the use of hydrogen peroxide. The hydrogen peroxide is believed not to have any effect on the flavor of the product. Bleaching of bran compositions is described further in co-pending U.S. patent application Ser. No. 09/663,914 to Monsalve-Gonzalez et al., entitled “Bleached Bran And Bran Products And Methods Of Preparation.”

Modified Product Composition

The hydrolyzed fiber-based products can have very desirable characteristics with respect to their composition. Specifically, the modified product can have desirable levels of soluble fiber content and a higher proportion of soluble fiber for a particular total dietary fiber content. Thus, these modified products can be incorporated into food products with desirable characteristics with respect to taste, color and texture while providing desired soluble fiber levels. The increased soluble fiber content has been associated with increased bile binding and reductions in serum cholesterol. At the same time, the modified fiber-based products have very low levels of total lysinoalanine (LAL) and free LAL. Thus, potential health concerns associated with high LAL concentrations are avoided through the control and reduction of undesired protein hydrolysis.

For modified, i.e., hydrolyzed, wheat bran compositions, the concentration of soluble fiber generally is at least about 5%, in further embodiments, at least about 7% and in further embodiments from about 8% to 20%. However, achieving levels of 15% or more through the process described herein for wheat bran compositions can yield a product that has a bitter flavor or is discolored such that the product may not be suitable in as broad a range of applications as other levels of ingredients. In general, similar levels of soluble fiber can be achieved for other fiber-based compositions. From another perspective, one can consider the increase in soluble fiber content. In the modified fiber-based composition, there can be an increase of at least about 75%, in further embodiments at least about 150% (1.75×-2.5×), in other embodiments from about 200% to about 1200% and in additional embodiments from about 300% to about 1000% relative to the initial percent in the unmodified fiber-based composition. With respect to the weight ratio of soluble fiber to total dietary fiber, the ratio can be at least about 4.5%, in further embodiments at least about 8%, in other embodiments from about 10% to about 60%, and in additional embodiments, from about 15% to about 50%. With respect to the conversion of insoluble fiber to soluble fiber, the initial insoluble fiber generally is at least about 3% converted to soluble fiber, in further embodiments at least about 5%, in other embodiments from about 7% to about 60% converted, and in additional embodiments from about 10% to about 50% of the insoluble fiber is converted to soluble fiber. A person of ordinary skill in the art will recognize that additional ranges of soluble fiber contents and ratios as well as percent conversion of insoluble fiber to soluble fiber within the explicit ranges above are contemplated and are within the present disclosure.

Total lysinoalanine (LAL) levels refers to the detected amounts of lysinoalanine peptide combinations identified within a protein structure, while free LAL levels refers to lysinoalanine dipeptides free of a protein structure. Low LAL levels are advantageous due to potential concerns regarding LAL in foods as a possible relationship with renal toxicity. Although there are no limits on LAL levels in foods in the United States, Dutch law limits LAL levels in certain ingredients.

In some embodiments, total LAL concentrations in the modified fiber-based product are no more than about 500 parts per million (ppm), in further embodiments no more than about 450 ppm, in additional embodiments no more than about 425 ppm, and in other embodiments from about 400 ppm to about 100 ppm. Furthermore, free LAL levels, in some embodiments, are no more than about 5 ppm, in further embodiments no more than about 3 ppm, in other embodiments no more than about 2 ppm and in additional embodiments from about 1 ppm to 0.1 ppm. In some embodiments, the free LAL levels may be undetectable. A person of ordinary skill in the art will recognize that additional ranges of LAL concentrations within the explicit ranges above are contemplated and are within the present disclosure.

Amino acid analysis can be performed on Beckman Instruments Models 6300 or 7300 dedicated amino acid analyzers. These instruments incorporate 10 cm cation exchange columns, three sequential sodium-based eluents, and sodium hydroxide for column regeneration. Absorbance is measured at 440 and 570 nm following post-column color development by ninhydrin reagent at 131° C. Data acquisition and management is accomplished with a computer running Beckman System Gold 8.10 chromatography software. Beckman reference solutions fulfill standardization requirements. (S)-2-Aminoethyl-1-cysteine (S2AEC) or glucosaminic acid is added to the samples as an internal standard. The Beckman amino acid analyzer can be employed to evaluate hydrolyzed amino acid content (protein bound LAL) or free amino acid content (unbound LAL). To determine the free LAL levels, a 2.0 g sample is extracted for 30 minutes with 20 mls of HPLC-grade water. The extraction solution is centrifuged, and the liquid is poured off. The liquid is then diluted 1:2 with the buffer/internal standard for use with the apparatus and filtered. The filtered liquid is then injected into amino acid analyzer.

To determine bound LAL, up to 1000 mg of sample is weighed into a 10 milliliter (ml) vacuole. A 400 microliter (μl) quantity of 1% phenol in water and 1000 μl of concentrated HCl are pipetted into the vacuole. Then, the vacuole is sealed with a torch. The sealed sample is digested in an oven for 21 hours at about 115° C. After digestion is complete, the vacuoles are cooled to room temperature. The cooled samples are vortexed to homogenize the slurry. The homogenized slurry is transferred to an appropriate sized volumetric flask using a Pasteur pipette. Sufficient Beckman “Na—S” buffer solution is added to make a 10 ml volume. The diluted solution is analyzed in a standard manner with the Beckman Amino Acid Analyzer.

The modified fiber-based composition that is obtained by the present example can then be used with or incorporated as an ingredient in a food intermediate. The term food “intermediate” as used herein refers to at least one intermediate that undergoes a further processing step, such as baking, mixing, etc. before the final food product is formed. In food processing, one or more intermediates can be formed. An example of a food intermediate is dough that can be used in the formation of breads, breakfast cereals, pasta, muffins, rolls and the like. Both cooked and uncooked doughs are contemplated herein

As discussed above, it has been found that modified wheat bran processed to increase the soluble fiber content has improved soluble fiber content. In vitro text results of bile acid binding are provided in Example 1 below. Also, it has been surprisingly discovered, that by increasing the soluble fiber content of the starting material through the process described in the present invention a reduction of up to 25% of the cholesterol level of hamsters can be obtained through use of the modified bran obtained by the process of the present invention over untreated or unmodified bran. The Hamster results are described further in co-pending U.S. patent application Ser. No. 10/207,601 filed on Jul. 29, 2002 to Dreese et al., entitled “Method And Ingredient For Increasing Soluble Fiber Content To Enhance Bile Acid Binding, Increase Viscosity, And Increase Hypocholesterolemic Properties.” Also, reductions in human serum cholesterol levels have been observed in carefully controlled studies with human patients with comparisons with consumption of oat bran with inherent high soluble fiber levels. These human studies and their results are summarized in co-pending U.S. Provisional Patent Application Ser. No. 60/660,016 filed on Mar. 9, 2005 to Reid et al., entitled “High Soluble Fiber Compositions For Cholesterol Reduction.”

The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention. This application is intended to cover any adaptations or variations of the invention. It is intended that this invention be limited only by the following claims, and the full scope of equivalents thereof.

### EXAMPLES

### Example 1

### Batch Processing with Low Shear Mixing

In specific examples, the dry ingredients, wheat bran (approximately 90-98% on a dry weight basis in this example is 10 pounds) and calcium hydroxide (2-10% on a dry weight basis and approximately 0.8 pounds for this exemplary process) are mixed together are then added into the cooker. The cooker has an initial shell temperature of around 21° C.-24° C. (70-75° F.).

The wheat bran is then steamed/cooked in a pressurized vessel. For the present example, the heating/steaming is done in three stages or durations of 10 minutes, 10 minutes and 20 minutes. During the heating/steaming, the pressure in the vessel is maintained at around 275 kPa to 350 kPa (25 to 36-psig). The cooking/steaming temperature ranges from about 130° C. to 138° C. and the heating/steaming is done in a batch cooker designed and used in the production of ready to eat (“RTE”) cereals. The contents are then discharged from the cooker. The batch after removal from the cooker had a moisture content of approximately 46%.

After the cooking step (the heating/steaming), the ingredients are mixed in a Hobart mixer. Citric acid is then added to neutralize the bran during the mixing. In the present embodiment, approximately 0.82 grams of citric acid is used for roughly each gram of alkali (calcium hydroxide) that was added. The cooked neutralized bran is then dried for twenty minutes at a temperature of 93° C.-99° C. (200°-210° F.) to obtain a moisture content of about 12%. The dried bran is then allowed to equilibrate overnight and is then ground to a powder with a mill.

Equivalent batch runs were performed for fifteen samples, and the total LAL and free LAL levels were measured for each sample. The results are plotted in FIG. 2. As can be seen from the Figure, the amounts of total LAL varied over a range from 450 ppm to 700 ppm while free LAL values varied form about 2 ppm to over 10 ppm. Thus, the low shear batch process yields considerable variation in the LAL results.

In a further example, the dry ingredients (wheat bran 90-95% and calcium hydroxide 5-10%) are mixed together and then added into a cooker having a shell temperature of 21°-24° C. (70°-75° F.). The ingredients are rolled and subjected to a vacuum of 98 kPa (−25 Torr) for five minutes. The ingredients are cooked for 30 minutes at a pressure of 345 kPa (≈35 psig).

After the cooking/steaming, vacuum is pulled for five minutes. After this initial period, a vacuum is pulled for an additional two minutes and cold water spray is added. The cooker is then opened and the contents discharged.

The contents are then mixed in a Hobart mixer and the bran is neutralized through the addition of citric acid while the solution is being mixed. After mixing, the bran is dried for 20 minutes for between 93°-100° C. (200-210° F.), milled by use of a Fitz mill and then dried for another 10 minutes. Once the mixture equilibrates overnight, the mixture is then ground further with a pin or disc mill.

In using the above process, the bran appeared lighter in color than in the first described process, presumably due to the reduction of Maillard browning reactions and other oxidation processes.

In vitro tests were conducted to determine the level of bile acid binding in connection with a wheat bran that had been modified in accordance with the present example in comparison with an unmodified wheat bran. The following results were obtained and are shown in the table below.

TABLE 1

| | | Viscosity | |
|---|---|---|---|
| | Bile Acid Binding | at 37° C. | Soluble |
| Component | (% of Cholestyramine) | cP * g/cm³ | Fiber, % |
| Unmodified White | 6.4% | 2.03 | 2.7% |
| Wheat Bran | | | |
| Ca(OH)₂ modified | 10.5% | 8.61 | 10.2% |
| White Wheat Bran | | | |

As table 1 illustrates, the process of the present invention improved the bile acid binding capability of the wheat bran by approximately 70% due to the increase in the level of soluble fiber and/or viscosity.

An exemplary food was prepared consisting of a ready to eat (RTE) cereals. This exemplary RTE cereal is in the form of flakes that are created by preparing a cooked cereal dough through known methods and then forming the cooked cereal dough into pellets that have a desired moisture content. The pellets are then formed into wet flakes by passing the pellets through chilled roller and then subsequently toasting or heating the wet cereal flakes. The toasting causes a final drying of the wet flakes, resulting in slightly expanded and crisp RTE cereal flakes. The flakes are then screened for size uniformity. The final flake cereal attributes of appearance, flavor, texture, inter alia, are all affected by the selection and practice of the steps employed in their methods of preparation. For example, to provide flake cereals having a desired appearance feature of grain bits appearing on the flakes, one approach is to topically apply the grain bits onto the surface of the flake as part of a coating that is applied after toasting.

The following table represents the RTE flake cereal prepared in accordance with the present example in which approximately 30% of the wheat used in the flake cereal has been replaced with the modified bran of the present invention.

TABLE 2

| | Standard | | Modified Bran | |
|---|---|---|---|---|
| Description | Flake Cereal | | Flake Cereal | |
| Total Fiber | 3.0 | g | 5.0 | g |
| (g/serving) | | | | |
| Soluble Fiber | 0.41 | g | 1.09 | g |
| (g/serving) | | | | |
| Calcium | 0 | mg/serving | 14.4 | mg/serving |
| (w/out fortification) | | | | |

The analysis provided in table 2 above, illustrates the increased level of soluble fiber in the RTE cereal by using the modified bran of the present invention in lieu of wheat bran obtained from conventional sources.

While the foregoing example is directed to the manufacture of flake cereals, it is readily apparent, that the manufacturing method can be modified to produce puffed or extruded cereals as well, in which the dough after forming is either fed through an extruder to create the desired shape or, in the alternative, is forced through a die or other orifice to generate puffed cereals.

In another batch, low shear example, wheat shorts were obtained and the process as described above was followed except that the wheat shorts were treated with sodium hydroxide at a pH of 12.1 for one hour. The wheat shorts were then neutralized with hydrochloric acid to a pH of approximately 6.8.

In conducting a comparison of the bile acid binding properties of the wheat shorts obtained by the above mentioned process, an arabinogalactan—a soluble fiber marketed under the name LAREX available from Larex, Inc. of St. Paul, Minn. LAREX, has been shown to reduce cholesterol levels but is an expensive ingredient. The following results show the amount of bile acid binding of a sample of material prepared in connection with the invention compared with Larex (micrograms of bile acid per milligram of sample).

TABLE 3

| Sample | Binding (% of cholestyramine) |
|---|---|
| Wheat Shorts | 12.6 |
| LAREX | 7.5 |

The wheat shorts used in the alternative embodiment after undergoing treatment according to the above process showed a soluble fiber content of approximately 24% on a dry weight basis.

### Example 2

### Addition of L-Cysteine During Batch Processing Example 2—Addition of L-Cysteine During Batch Processing

In this example, LAL levels are evaluated following the addition of L-cysteine to the hydration mixture.

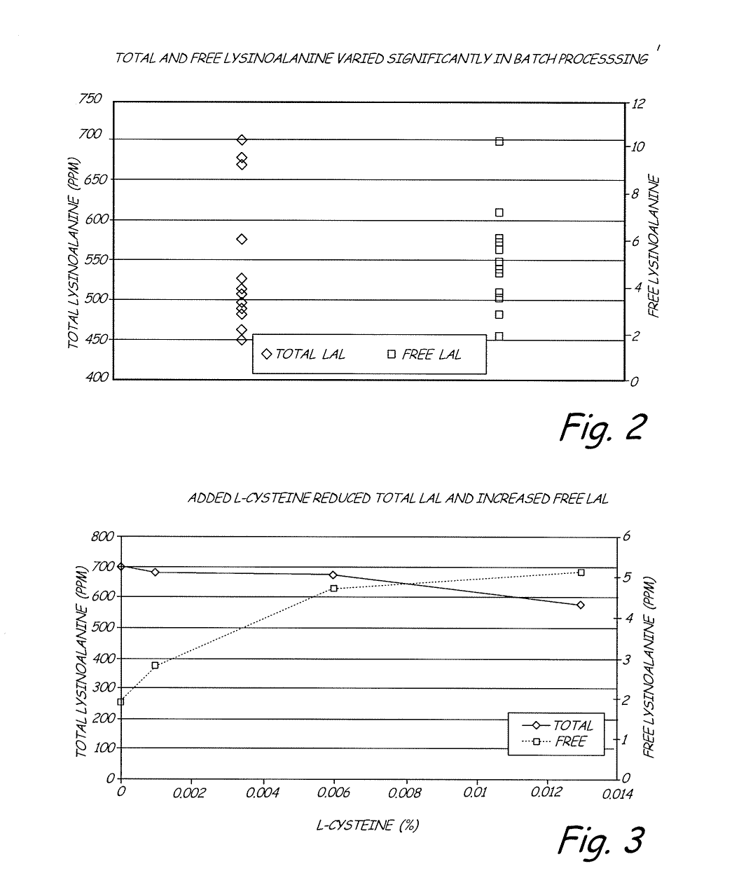

The batch process described in the first portion of Example 1 was repeated with L-cysteine added to the hydration mixture. The results for total LAL and free LAL for three different concentrations of L-cysteine in % are plotted in FIG. 3. From these results, the addition of L-cysteine lowers the total LAL levels, but raises the free LAL levels.

### Example 3

### Wheat Bran Hydrolysis Using Extrusion

In this example, results are presented using an extrusion based cooking process that yield improved bran products with increased soluble fiber content.

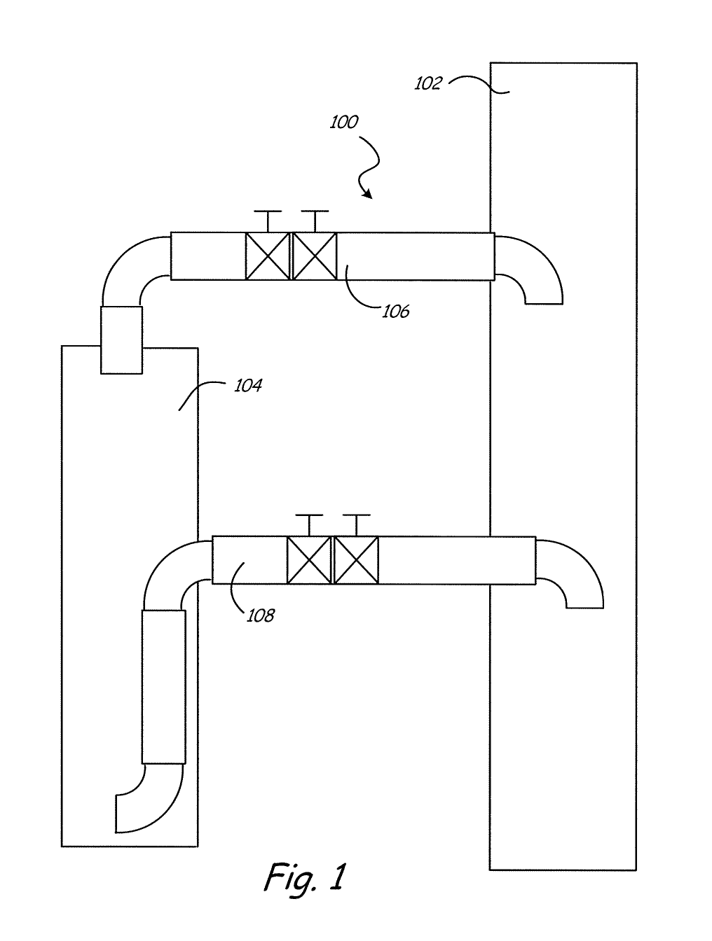

The apparatus is shown schematically in FIG. 1. Apparatus 100 comprises a Buhler 62 twin-screw extruder 102, an adiabatic flow vessel 104, a channel connection 106 from the extruder to the vessel and channel 108 from the vessel back to the extruder. The distance between screw tips in extruder 102 is 62 millimeter. Extruder 102 is a co-rotating, interesting, modular twin-screw extruder. Adiabatic flow vessel 104 is a 5 foot long, 10 inch diameter insulated vessel with a high volume that provides an effective additional residence time. The twin-screw extruder provides mixing, pumping and heat transfer.

The extruder operation is carried out in separate temperature-controlled extruder zones that are fed by several separate input streams. The temperatures in the different zones of the extruder are presented in Table 4. The inputs are described in Table 5. A loss-in-weight feeding system feeds dry ingredients (DF1, DF2) into zone 1 of the extruder. Metering feed pumps feed liquids (LF1, LF2) into zone 2. Steam (SF1) was injected into zone 3 to provide enthalpic heat with efficient heat transfer. Mixing paddles in zones 3 and 4 mix the feed materials to provide a homogenous feed to vessel 104. The extruder was operated at 250 rpm. In zone 5, the material is diverted from the extruder barrel into vessel 104. Reversing elements in zone 6 ensure that the material does not bypass the vessel. In zone 7, the material returns to the extruder barrel from vessel 104. Mixing elements in zones 9 and 10 provide uniform mixing of the neutralizing acid and the previously alkaline product. Also, conveying elements in zone 10 provide the head pressure necessary to pump the neutralize product through the die.

TABLE 4
Extruder Zone Temperature Set Points

| Extruder | Set Point |
|---|---|
| Zone | Temperature (° F.) |
| 1 | None |
| 2 | 150 |
| 3 | 180 |
| 4-8 | (225-350) |
| 9-10 | (225-325) |

TABLE 5
Extruder feed specifications and restrictions

| Extruder | | | |
|---|---|---|---|
| Feed | Description | Feed Specification (lb/hr) | Restriction |
| DF1 | Wheat Bran | 300-600 | |
| DF2 | Ca(OH)₂ | 0 ≧ DF2 ≧ 0.08 * DF1 | 0.08 ≧ (DF2 + LF2_{Ca(OH)2})/DF1 ≧ 0.02 |
| LF1 | Water | 0.05 * DF1 ≧ LF1 ≧ 0.39 * DF1 | 0.20 < ^{#}MC < 0.40 |
| LF2 | Ca(OH)₂ | LF2 = 6 * LF2_{Ca(OH)2} | |
| | Suspension | | |
| LF2_{Ca(OH)2} | Ca(OH)₂ in | 0 ≧ LF2_{Ca(OH)2} ≧ 0.08 * DF1 | 0.08 ≧ (DF2 + LF2_{Ca(OH)2})/DF1 ≧ 0.02 |
| | LF2 | | |
| LF3 | Citric Acid | LF3 = 2 * LF3_{Citric} | |
| | Solution | | |
| LF3_{Citric} | Citric Acid in | LF3_{Citric} = 0.85 * LF2_{Ca(OH)2} | |
| | LF3 | | |
| SF1 | Steam | SF1 = 0.14 * DF1 | |

^{#}MC is the calculated wet basis moisture at the feed to the vessel 104. The restrictions imply that the total calcium hydroxide should be between 2 wt % and 8 wt % of the bran feed, and the feed moisture content should be between 20% and 40%.

The feed specifications of 300 to 600 pounds (136 kg to 272 kg) per hour are based on the particular processing apparatuses with the specific extruder size and vessel volume of 2.5 cubic feet (0.0708 m³). The system can be scaled according to standard extruder scaling rules. The specification of feed rate and Ca(OH)₂ provide for a range of operating conditions to achieve the target composition, functionality and sensory attributes while reducing or eliminating undesirable by-products.

Following the extrusion operation, the product is conveyed to a final drying and grinding operation. The product is dried to a final moisture content to ensure stability and ground to a selected particle size.

The results for three specific runs are presented. The conditions for the extrusion are presented in Table 6.

TABLE 6
Summary of run conditions:

| | Sample | | |
|---|---|---|---|
| | 1 | 2 | 3 |
| Screw speed (rpm) | 250 | 250 | 250 |
| Bran Feed Rate (lb/hr) | 350 | 350 | 350 |
| Barrel Steam (lb/hr) | 50 | 50 | 50 |
| Citric acid level (% of lime feed) | 82% | 82% | 82% |
| Calcium hydroxide (% of bran feed) | 4% | 4% | 4% |
| Water feed rate (lb/hr) | 28 | 37.5 | 28 |

The temperatures in the 10 zones of the extruder are presented in Table 7.

TABLE 7
Barrel temperature profile (10-barrel set-up)

| Zone | Temperature (F.) |
|---|---|
| A | OFF |
| B | 150 |
| C | 180 |
| D | 250 |
| E | 325 |
| F | 325 |
| G | 350 |
| H | 350 |
| I | 250 |
| J | 250 |

The resulting hydrolyzed products were subjected to analytical analysis. The results of the analysis are presented in Table 8.

TABLE 8
Analytical Testing of Modified Wheat Bran (% wb)

| | 1 | 2 | 3 |
|---|---|---|---|
| Total Dietary Fiber | 41.9 | 39.0 | 33.4 |
| Insoluble Fiber | 23.7 | 27.2 | 21.1 |
| Soluble Fiber | 18.2 | 11.8 | 12.3 |
| Total Fat | 4.2 | 4.1 | 5.1 |
| Saturated Fat | 0.7 | 0.8 | 0.8 |
| Monounsaturated Fat | 0.8 | 0.8 | 1.1 |
| cis-cis Polyunsat Fat | 2.4 | 2.4 | 2.9 |
| Total Protein (N × 6.2) | 17.5 | 17.2 | 14.9 |
| Total Lysinoalanine (ppm) | 119 | 398 | 425 |
| Free Lysinoalanine | N.D. | N.D. | N.D. |
| Total Sugar/Starch | 12.2 | 21.9 | 29.9 |
| Sugars | 2.6 | 3.5 | 3.6 |
| Glucose No. | 1.2 | 1.8 | 1.3 |
| Starch | 8.4 | 16.6 | 25.0 |
| Moisture | 3.6 | 5.6 | 3.3 |
| Ash | 14.1 | 8.9 | 9.4 |
| Organic Acids | 7.4 | 5.1 | 5.0 |
| Citric Acid | 5.1 | 3.8 | 3.4 |
| Lactic Acid | 2.3 | 1.3 | 1.6 |
| Total | 100.9 | 101.8 | 101.0 |

The evaluation of the fiber content and the lysinoalanine levels were discussed in detail above. LAL measurements were performed by Scientific Research Consortium, Inc.

The free lysinoalanine levels were not detectable indicating a value below about 0.4 ppm were obtained, which is the detection limit in the present approach. The total lysinoalanine values were well within acceptable levels. At the same time, the soluble fiber levels were within desired ranges. The soluble fiber content of the initial bran was about 2% for each of the three samples. Thus, about 41%, 26% and 33%, respectively, of the initial insoluble fiber was converted to soluble fiber for the three samples. These results demonstrate that the processes are effective to produce consistent desired results with little or no undesirable protein hydrolysis by-products.

What we claim is:

1. A method for hydrolysis of a grain product to increase soluble fiber content, the method comprising:
mixing at high shear a mixture comprising a grain product with dietary fiber, a base and water at a pH from about 10 to about 13 to form a homogenous mixture that hydrolyzes following heating with respect to the insoluble fiber.

2. The method of claim 1 wherein the mixing is performed in a continuous method.

3. The method of claim 2 wherein the mixing is performed with an extruder.

4. The method of claim 3 wherein the extruder is a twin screw extruder operating at least about 50 revolutions per minutes.

5. The method of claim 1 wherein the mixing is performed in a high shear mixer.

6. The method of claim 1 wherein the mixture comprises wheat bran and the mixture has a dry dietary fiber content of at least about 20%.

7. The method of claim 1 wherein the mixture comprises from about 25% water to about 80% water.

8. The method of claim 1 wherein the resulting hydrolyzed product has a soluble fiber content of at least about 8%, a ratio of soluble fiber to insoluble fiber of at least about 0.2.

9. The method of claim 1 wherein the resulting hydrolyzed product has no more than about 500 ppm total lysinoalanine.

10. The method of claim 1 wherein the resulting hydrolyzed product has no more than about 425 ppm total lysinoalanine.

11. The method of claim 1 wherein the mixture comprises at least about 0.002% L-cysteine.

12. A grain product comprising at least about 20% dietary fiber comprising polysaccharides with arabanogalactan linkages, having at least about 8% soluble fiber, a ratio of soluble fiber to total dietary fiber of at least about 0.08 and no more than about 500 ppm total lysinoalanine.

13. The grain product of claim 12 wherein there is no more than about 425 ppm total lysinoalanine.

14. The grain product of claim 12 wherein there is no more than about 3 ppm free lysinoalanine.

15. The grain product of claim 12 having at least about 10% soluble fiber.

16. The grain product of claim 12 having a ratio of soluble fiber to dietary fiber of at least about 1:10.

17. The grain product of claim 12 having at least about 30% dietary fiber.

18. A food composition comprising at least about 20% soluble fiber with polysaccharides having arabanogalactan linkages, from about 35% to about 65% water, a pH from about 10 to about 13.

19. The food composition of claim 18 wherein there is no more than about 500 ppm total lysinoalanine.

20. The food composition of claim 18 wherein thee is no more than about 425 ppm total lysinoalanine.
